(19) United States
(12) Patent Application Publication
(10) Pub. No.: US 2024/0296473 A1
(43) Pub. Date: Sep. 5, 2024

(54) SYSTEM AND METHOD FOR SOCIAL THROTTLING

(71) Applicant: Capital One Services, LLC, McLean, VA (US)

(72) Inventors: Michael MOSSOBA, Great Falls, VA (US); Timur SHERIF, Silver Spring, MD (US); Amita SHARMA, Potomac, MD (US)

(73) Assignee: Capital One Services, LLC, McLean, VA (US)

(21) Appl. No.: 18/116,597

(22) Filed: Mar. 2, 2023

(51) Int. Cl. G06Q 30/0226; G06Q 30/0207; G06Q 50/00

(52) U.S. Cl. CPC G06Q 30/0226; G06Q 30/0224; G06Q 50/01

(57) ABSTRACT

A system and method for discounting the cost of goods based on social throttling is disclosed. A discount system is provided with discounting parameters that can include a starting price for the good, a price progression of the good based on the numbers of purchases, a maximum discount, and other parameters. During the promotion, as the number of purchases increases, the total discount also increases according to those parameters. Additionally, further discount incentives can be provided to individuals who promote the promotion on social media, or based on other factors, such as whether they are early adopters or frequent participants. Accordingly, the retailer benefits from increased sales and the customers benefit from reduced prices.

### TECHNICAL FIELD

Embodiments of the present disclosure are related to merchant transactions, and specifically to adjusting the price of goods based on social stimulants.

### BACKGROUND

Traditionally, the price of goods is fixed according to a merchants designation. Specifically, the merchant can choose to sell a particular good or service for a manufacturer's suggested retail price (MSRP), an elevated price, or a discounted price. Regardless, the customer has little control over the price of the product, which is almost unilaterally decided by the merchant.

### BRIEF DESCRIPTION OF THE DRAWINGS/FIGURES

The accompanying drawings are incorporated herein and form a part of the specification.

FIG. 1 illustrates a block diagram of exemplary social pricing environment according to various embodiments.

FIG. 2 illustrates a block diagram of an exemplary social pricing system according to various embodiments.

FIGS. 3A-3B illustrate line graphs of exemplary price adjustment schemes according to various embodiments.

FIG. 4 illustrates a flowchart diagram of an exemplary method for applying social pricing according to various embodiments.

FIG. 5 illustrates a flowchart diagram of an exemplary method for applying social pricing according to various embodiments.

FIG. 6 illustrates an exemplary computer system for implementing some aspects of the disclosure or portion(s) thereof.

In the drawings, reference numbers generally indicate identical or similar elements. Additionally, generally, the left-most digit(s) of a reference number identifies the drawing in which the reference number first appears.

### DETAILED DESCRIPTION

Provided herein are a method, a system, computer program product embodiments, and/or combinations and sub-combinations thereof for adjusting prices of goods and/or services based on social throttling.

Traditionally, the price of goods is fixed according to a merchants designation. Specifically, the merchant can choose to sell a particular good or service for a manufacturer's suggested retail price (MSRP), an elevated price, or a discounted price. Regardless, the customer has little control over the price of the product, which is almost unilaterally decided by the merchant. Without being able to influence the price of goods/services, the public rarely spreads enthusiasm for particular goods/services because they are not incentivized to do so. Although this disclosure is equally applicable to sale of goods and services, the disclosure will be discussed in terms of the sale of goods for ease of explanation.

Therefore, the present disclosure provides a mechanism to allow customers to benefit from the purchase of particular goods through social throttling and interaction. As a result, enthusiasm for the purchase of the goods increases, as does the amount of sales of that particular good. This creates a mutually beneficial incentive between the merchant and the customer for those purchases. As a result, customer satisfaction increases as well as total product sales. This creates a benefit both for the merchant selling the product as well as for the consumers.

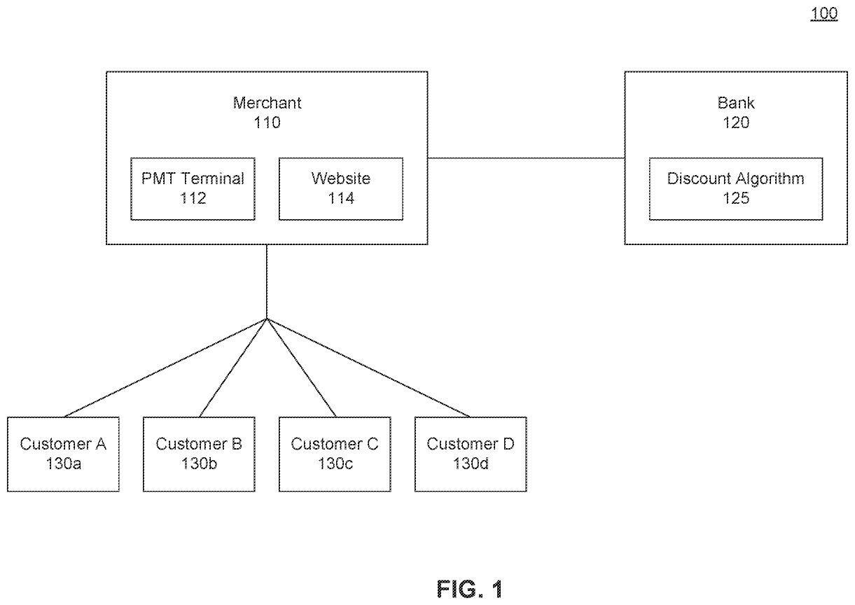

FIG. 1 illustrates a block diagram of exemplary social pricing environment 100 according to various embodiments. As shown in FIG. 1, the environment 100 includes a bank 120 or other financial institution that processes purchases. The bank 120 includes the discount algorithm 125 that calculates the adjusted pricing.

The bank 120 communicates with a merchant 110, which controls the sale of the goods. The merchant 110 may effectuate the sale of the goods using a variety of different methods, such as via a point of sale using a payment terminal 112, or over the Internet via a website 114 and its payment interface. Any number of customers (e.g., Customers A-D 130a-130d) may interact with the merchant's various payment methods in order to purchase the goods.

In operation, when a merchant is involved in the one of the social throttling schemes of the present embodiment, the merchant 110 essentially agrees to the price of the goods being reduced based on customer activity. For example, in different embodiments, the merchant can allow for the price of the goods to be reduced based on the number of units sold, and can provide customer-specific incentives for actively promoting the goods and/or the throttling sale. This is made possible by the delay, common with credit-card and other electronic based purchases, being made final. As with most credit card purchases, there is a period of time during which the transaction is pending. During this time, the transaction has not been finalized, and exists in a sort of preliminary state. After a period of time, the transaction converts from a pending transaction (e.g. temporary/interim) to a posted transaction (e.g., finalized). When a transaction becomes posted, the total payment amount as well as the transaction is finalized. At this point, the transaction amount can no longer be changed.

In an example, throughout the throttling sale, customers 130a-130d gradually complete a purchase of the goods from the merchant 110. Each completed purchase is provided to the bank 120, which tracks the total number of completed purchases of that particular good through use of the discount algorithm. Provided that the final price charged to the customer is adjusted prior to the purchase posting (e.g., being finalized), then the customer can benefit from the throttling sale even after their personal purchase has been made. In other words, while a customer's transaction is pending, the bank 120 can aggregate sales of the good and determine reduced pricing of the good according to the discount algorithm, which will be discussed in further detail below. The bank 120 then applies the discounted price to the purchase rather than the original purchase price when posting the transaction. These and other aspects are described in further detail below.

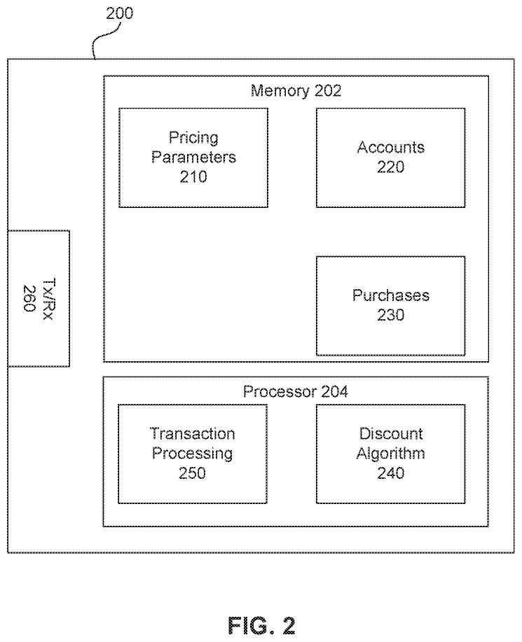

FIG. 2 illustrates a block diagram of an exemplary social pricing system 200 according to various embodiments. In the example provided above, the social pricing system 200 may be located at a bank or other financial institution, such as a credit card company. However, other embodiments are also envisioned, such as where the social pricing system 200 is provided to individual merchants so that they can directly control their pricing and notification schemes.

As shown in FIG. 2, the social pricing system 200 includes pricing parameters 210, accounts 220, purchases 230, discount algorithm 240, transaction processing 250, and a transceiver 260. As shown in FIG. 2, at the pricing parameters 210, accounts 220 and purchases 230 are stored in memory 202. Similarly, a processor 204 executes the discount algorithm 240 and the transaction processing 250.

In embodiments, the discount algorithm can be either preconfigured or can be configured according to merchant specifications. In the latter scenario, the social pricing system 200 communicates with the merchant via the transceiver 260 to receive from the merchant the specifications for applying the discount algorithm. In embodiments, these parameters include the specific good to which the discount will apply, the starting price, a maximum discount, ending time, and a discount scheme, which will be discussed in further detail below. The social pricing system 200 uses these parameters to configure discount algorithm 240. In an alternative embodiment, most of the parameters can be preconfigured by the social pricing system 200. Specifically, once the specific good being discounted and its starting price have been identified, the system 200 can automatically configure the discount algorithm 240 with a maximum discount price as a percentage of the starting price, and can automatically set the discount scheme to a preset scheme.

In some embodiments, discounts are applied on an account-by-account basis. For example, different pricing adjustments can be applied for early adopters, late adopters, promoters, etc. Thus, the accounts 220 stores account information associated with different purchasers, such as customers 130a-130d. In some embodiments, discount adjustments are applied according to social media promotion. As a result, the accounts 220 also includes information relating to customer social media accounts. In an embodiment, the social media accounts are linked with the customer's financial accounts.

Purchases 230 aggregates and tracks the purchases of the particular good. Specifically, purchases 230 stores each purchase of the good, along with certain identifying data, such as customer name, customer account, date/time of purchase, etc.

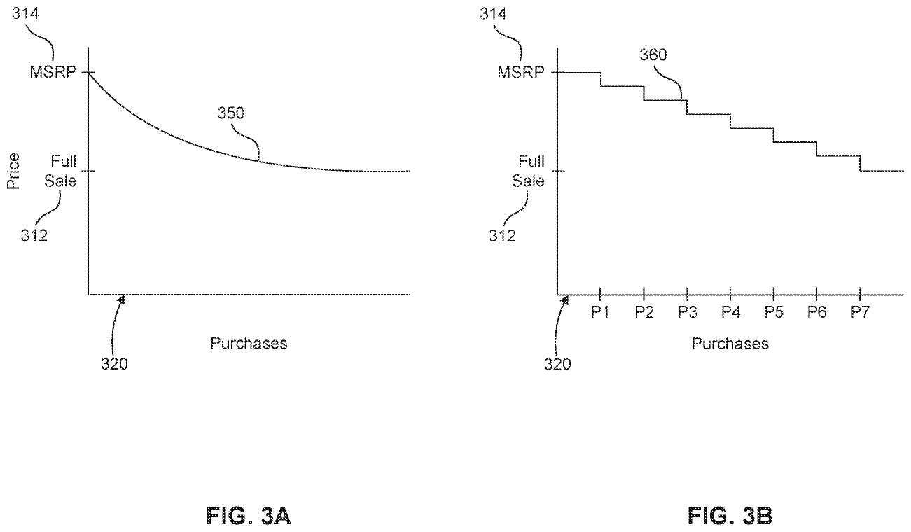

Discount algorithm 240 is configured according to the parameters described above and cooperates with transaction processing 250 to carry out the discounting of the good based on the purchases and social throttling. Specifically, in embodiments, when a purchase is made, the transaction processing 250 processes the purchase and creates the pending transaction. The purchase is stored in the purchases 230. During the pendency of the promotion, the discount algorithm 240 accesses the purchases 230 to determine a number of total purchases that have been made of the good. The discount algorithm then applies this value to the discount scheme in order to determine a current discount, as shown for example in FIGS. 3A and 3B.

FIGS. 3A-3B illustrate line graphs of exemplary price adjustment schemes according to various embodiments. Each of the line graphs shows a starting price 314 (e.g., an MSRP), and a maximum discounted (e.g., full sale) price 312 along the vertical axes. Along the horizontal axes are the number of purchases 320.

In the example of FIG. 3A, the discount scheme is a continuous one, where the price is gradually discounted according to an equation as the number of purchases increases. This is defined by curve 350. As shown in FIG. 3A, the curve is continuous. Thus, each additional purchase functions to gradually reduce the final price of the goods up to the maximum discount 312.

Meanwhile, FIG. 3B shows a stepwise discount scheme 360. In FIG. 3B, the price of the good is not reduced for each purchase. Instead, there are one or more purchase milestones that must be met (e.g., P1-P7). Thus, when the total number of purchases exceeds a next threshold, the price is reduced according to the corresponding step. For example, in the example of FIG. 3B, when the total number of purchases meets milestone P1, the price is discounted according to the first step. Similar discounts occur for milestones P2-P7 up to the maximum discount 312.

Returning to FIG. 2, in an embodiment, the discount algorithm 240 can apply the purchases to the discount scheme at the conclusion of the promotion. In this way, the algorithm is only performed once. Alternatively, in order to increase the motivation of potential customers, the latest discounted price is calculated in an ongoing basis. In order to apprise the customers of latest prices, the processor 204 can further cause the transceiver 255 to transmit notifications to users. Example notifications may read “Congratulations! Enough people have purchased this item to reduce its price to $DD.CC. Keep it up!”

In embodiments, the discounts can be further personalized for each individual purchaser according to other factors. For example, the discount algorithm 240 uses the discount scheme to calculate a base discount price based on the number of purchases that have been made. The discount algorithm 240 can then consider additional information relating to individual users to determine whether further discount or increase the price from that base amount. For example, new customers and late adopters (those late in the discount cycle) may see an increase from the base discount price. Similarly, promotors (e.g., those whose social media accounts discussed or otherwise promoted the promotion) and early adopters may see a decrease from the base discount price. Other factors may also be considered when calculating individualized discounts.

Upon the conclusion of the promotion, transaction processing 250 modifies the prices of the pending transactions into their discounted final prices and posts each of the pending transactions at their discounted final prices for each of the different customers as calculated by the discount algorithm 240. In this manner, prices of goods are not static, but rather can be changed based on customers' social influence.

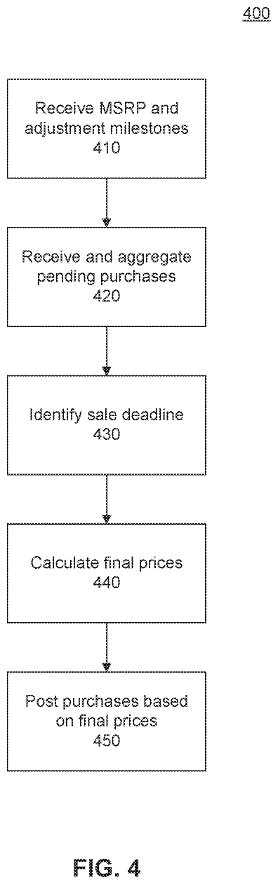

FIG. 4 illustrates a flowchart diagram of an exemplary method 400 for applying social pricing according to various embodiments. FIG. 4 shows a method whereby the discounts are calculated at the conclusion of a promotion. As shown in FIG. 4, the method begins by receiving a starting price and discount scheme (e.g., adjustment milestones) in step 410. These are used to configured to the discount algorithm. Then, throughout the pendency of the promotion, pending purchases are received and aggregated in step 420.

In step 430, the end of the promotion is identified. At this time, the final discounted prices are calculated in step 440. As discussed above, in different embodiments, these prices can be constant across the customer base. However, in other embodiments, the discounts can be customized for each user based on their involvement in the promotion, as discussed above. Once the final purchase prices have been calculated by the discount algorithm, the transactions are posted in accordance with those prices in step 450.

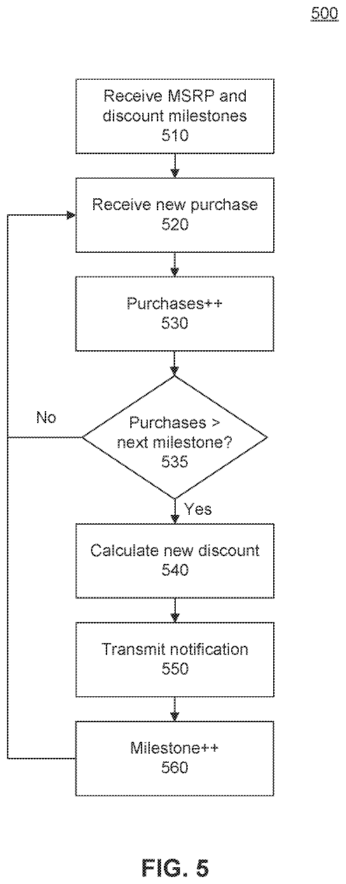

FIG. 5 illustrates a flowchart diagram of an exemplary method 500 for applying social pricing according to various embodiments. FIG. 5 illustrates a method to enhance the social media engagement during a stepwise promotion.

As shown in FIG. 5, the method begins at step 510, where the discount parameters, such as starting price (e.g., MSRP) and discount scheme (e.g., discount milestones) are received. This information is used to configure the discount algorithm. Once configured, a new purchase is received in step 520. In step 530, the total number of purchases is incremented. This new total number of purchases is then compared to a next milestone. Specifically, a determination is made in step 535 as to whether the total number of purchases exceeds the next milestone. If it does not (535—No), then the method returns to step 520 to continue aggregating purchases.

However, if the total number of purchases exceeds the next milestone (535—Yes), then the discount algorithm calculates in step 540 a new discount price for the good associated with the milestone that was just reached. In order to enhance social engagement, a notification is transmitted in step 550 to the customers and/or the general public, informing them of the newest price reduction. Subsequently, the next milestone is incremented in 560. Thereafter, the method returns to step 520 to continue aggregating purchases.

The method continues in this manner until some terminating condition, such as the promotion time concluding or the price reaching a maximum discount. In this manner, social interactions among customers and potential customers can collectively increase revenue to the retailer and reduce cost to the customers.

Of course, several modifications may be available in the above methods. For example, in each scenario, either a stepwise or a continuous discount scheme may be used. Additionally, notifications may be sent to customers and/or the public upon the occurrence of certain events, such as the reaching of a new milestone, the conclusion of the promotion, or after certain amounts of time have elapsed since the start of the promotion or whether only certain amounts of time remain in the promotion. Alternatively, notifications can be sent periodically. Further, notifications can only be sent to potential customers, to all customers, and/or to the general public.

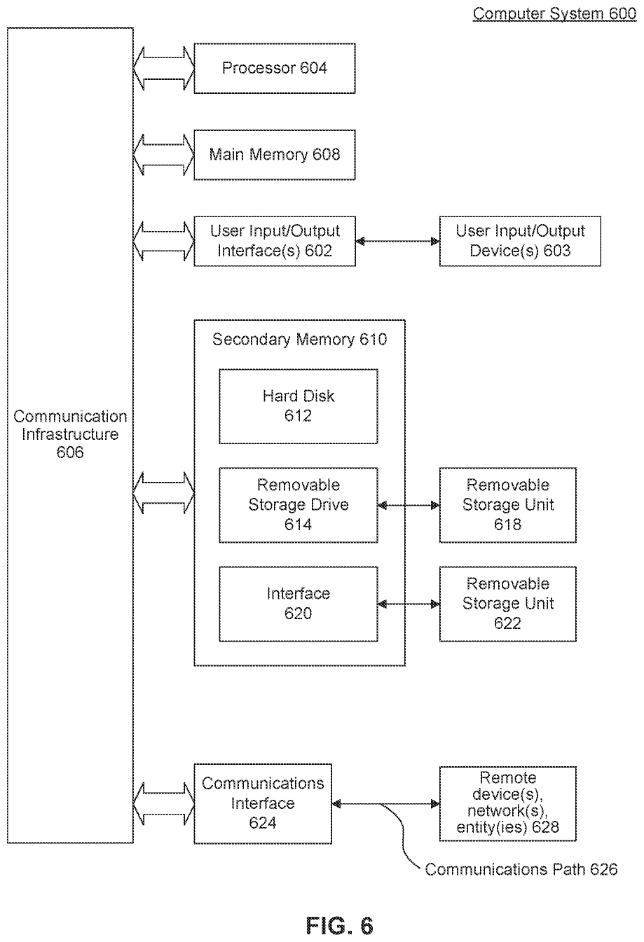

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1. A method for adjusting a price of an item based on social cooperation, comprising:
receiving a base price for the item from a merchant;
receive, via a transceiver communicating over a network, a plurality of customer classes and a corresponding discount progression for each of the plurality of customer classes from the merchant, each of the discount progressions defining at least one discount parameter including a price reduction progression based on purchase milestones of the item, wherein the plurality of customer classes include early adopter, late adopter, and promoter, and wherein different customers are associated different ones of the plurality of customer classes based on their involvement in a sale campaign associated with the item;
generate a price reduction algorithm based on the at least one discount parameter and the plurality of customer classes received from the merchant, and predefined default values for any parameters not provided by the merchant;
receive a plurality of pending purchases for the item;
receive a transaction from a user for the good at the base price, wherein the user is associated with one of the plurality of customer classes;
establish a pending transaction associated with the user based on the received transaction, the pending transaction being unfinalized and identifying the purchase price as the base price;
after a predetermined lapse of time from the establishment of the pending transaction associated with the user:
receive current sales numbers associated with the good based on the plurality of pending purchases;
determine a customer class associated with the user from among the plurality of customer classes;
select the discount progression corresponding to the customer class of the user;
calculate a final discounted price of the good based on the current sales numbers as applied to the price reduction algorithm, based on the selected discount progression; and
finalize the pending transaction associated with the user based on the final discounted price.

2. The method of claim 1, further comprising:
receiving an electronic message from the merchant that includes the at least one discount parameter, the at least one discount parameter including the base price and the discount progression, wherein the discount progression includes one of a discount curve that defines final purchase price of the good as a function of units sold, or a discount step that defines a plurality of discount amounts corresponding with a plurality of purchase volumes.

3. The method of claim 1, further comprising associating a purchasing account with a social media account.

4. The method of claim 3, further comprising tracking social media posts on the social media account associated with the item.

5. The method of claim 4, further comprising further discounting the final price based on the social media posts.

6. The method of claim 1, wherein the calculating the final price includes comparing the plurality of pending purchases to the purchase milestones.

7. The method of claim 6, wherein the calculating the final price further includes determining a highest purchase milestone achieved, and setting the final price to a price associated with the highest purchase milestone.

8. A price adjustment device, comprising:
a transceiver configured to receive a plurality of purchases of an item;
a memory that stores a plurality of predefined default parameters; and
one or more processors configured to:
receive a plurality of customer classes and a corresponding at least one discount parameter for each of the plurality of customer classes from a merchant via the transceiver over a network, wherein different customers are associated with different ones of the plurality of customer classes based on their involvement in a sale campaign associated with the item, the at least one discount parameter including a base price and a price progression associated with the item;
generate at least one price reduction algorithm based on the at least one discount parameter and the plurality of customer classes received from the merchant, and the plurality of predefined default parameters for any parameters not provided by the merchant;
track the plurality of purchases over a period of time;
receive a pending purchase from a user for the good at a base price, wherein the user is associated with one of the plurality of customer classes;
after a predetermined lapse of time from the establishment of the pending purchase from the user:
determine a customer class associated with the user from among the plurality of customer classes;
select the discount parameter corresponding to the customer class of the user;
calculate a savings amount based on the plurality of purchases, the price reduction algorithm, and the selected discount parameter;
transmit a notification to the user of the savings amount; and
finalize the purchase from the user at reduced amounts according to the calculated savings amount.

9. The price adjustment device of claim 8, wherein the price progression includes a plurality of purchase milestones, each associated with a corresponding savings amount.

10. The price adjustment device of claim 8, wherein the price progression includes a savings curve that models the savings amount based on a number of purchases.

11. The price adjustment device of claim 9, wherein the notification is transmitted in response to a surpassing of a new one of the plurality of purchase milestones.

12. The price adjustment device of claim 8, wherein the notification is a social media post.

13. The price adjustment device of claim 8, wherein the memory further stores a social media account in association with a purchasing account.

14. The price adjustment device of claim 13, wherein the one or more processors are further configured to:
identify a social media post on the social media account that promotes the item; and
apply a secondary savings amount to a purchase of the item associated with the purchasing account.

15. A social pricing method, comprising:
storing a plurality of predefined default parameters;
receiving a plurality of customer classes and a corresponding at least one discount parameter for each of the plurality of customer classes from a merchant via a transceiver over a network, the at least one discount parameter including a base price and a price progression associated with a promoted item, wherein different customers are associated with different ones of the plurality of customer classes based on their involvement in a sale campaign associated with the promoted item;
generating a price reduction algorithm based on the at least one discount parameter and the plurality of customer classes received from the merchant, and the plurality of default parameters for any parameters not provided by the merchant;
tracking a plurality of pending purchases of the promoted item over time;
receive a transaction from a user for the good at the base price, wherein the user is associated with one of the plurality of classes;
after a predetermined lapse of time from the establishment of the pending purchase from the user:
determine a customer class associated with the user from among the plurality of customer classes;
select the discount parameter corresponding to the customer class of the user;
calculating an updated purchase price of the promoted item based on the plurality of pending purchases and the price reduction algorithm, and a class associated with the user;
transmitting a notification to a purchaser of the updated purchase price; and
finalizing the purchase from the user based on the updated purchase price.

16. The social pricing method of claim 15, wherein the notification is a social media post.

17. The social pricing method of claim 15, wherein the price progression includes a plurality of purchase milestones, each associated with a corresponding savings amount.

18. The social pricing method of claim 15, wherein the price progression includes a savings curve that models the savings amount based on a number of purchases.

19. The social pricing method of claim 15, further comprising storing a social media account in correspondence with a purchasing account.

20. The social pricing method of claim 19, further comprising:
identifying a social media post that promotes the promoted item on the social media account;
applying a second updated price for a purchase made by the purchasing account in response to the identifying; and
transmitting a notification to a user of the social media account notifying them of the second updated price.
